(19) United States
(12) Patent Application Publication
(10) Pub. No.: US 2009/0091191 A1
(43) Pub. Date: Apr. 9, 2009

(54) ELECTRIC POWER SUPPLY SYSTEM

(75) Inventors: Satoshi Tomioka, Tokyo (JP); Eiji Takegami, Tokyo (JP)

Correspondence Address: DARBY & DARBY P.C., P.O. BOX 770, Church Street Station, New York, NY, 10008-0770, US

(73) Assignee: DENSEI-LAMBDA K.K., Tokyo (JP)

(21) Appl. No.: 11/869,114

(22) Filed: Oct. 9, 2007

(51) Int. Cl. H02J 3/00

(52) U.S. Cl. 307/75

(57) ABSTRACT

There is provided an electric power supply system in which electric power is delivered from one electric power unit to load or the other electric power unit and can control and monitor the other electric power unit by one electric power unit. An electric source bus is built up by connecting an output line 5 of a DC-DC converter 2 to each of POL converters 6a, 6b, 6c. Loads 7a, 7b are connected to each of outputs of the POL converter 6a, 6b, 6c. An electric power unit 1 delivers electric power to the POL converters 6a, 6b, 6c by means of the DC-DC converter 2 and besides has functions to control and monitor statuses of the POL converters 6a, 6b, 6c. From a high-order system 10, a sequence program 20 and a monitoring program 21 can be rewritten which fulfill the functions of controlling and monitoring.

### BACKGROUND OF THE INVENTION

1. Field of the Invention

The present invention relates to an electric power supply system which can control a plurality of electric power units and can deliver power supply voltages to a plurality of loads connected to the electric power units.

2. Description of the Related Arts

For example, circuit boards which are employed in those of devices such as computer devices, telecommunications equipment or the like typically require a plurality of power supply voltages. Moreover, many of LSIs, acting as load, require a plurality of power supply voltages. As an electric power unit capable of delivering electric power to a plurality of loads, one is disclosed in Japanese unexamined application publication No. 2001-352674. The electric power unit disclosed in the prior art distributes output electric power from an AC-DC converter to a plurality of loads through a failure detection unit equipped with an output control circuit.

Recently, POL (point of load) converters have become pervasive as an electric power unit which meets the requirement like this. The POL converter is a small-size and high-efficiency non-insulated-type converter, and is mounted on the nearest position of loads, thereby permitting a low-voltage and a large-current electric power to be delivered to the loads.

FIG. 3 shows one example of a conventional dispersed electric power supply system using the POL converters. Referring to FIG. 3, output line (electric power transmission line) 5 of a DC-DC converter 2 are connected to the POL converters 6a, 6b, 6c in parallel to thereby build 12 V buses. Devices, acting as load, e.g., such as LSIs are connected to the POL converters 6a, 6b, 6c to thereby make up a 12V bus line. Devices acting as load, e.g., the LSIs or the like are connected to the POL converters 6a, 6b, 6c. A load 7a is a device which requires two power supply voltages, 1.8V and 3.3V, and therefore the two power supply voltages are input to the load 7a from the POL converter 6a whose output voltage is set at 1.8V and the POL converter 6b whose output voltage is set at 3.3V. On the contrary, a load 7b is a device which requires only a 5V power supply voltage, and therefore one power supply voltage is input to the load 7b from the POL converter 6c whose output voltage is set at 5V. Between the POL converters 6a, 6b, start and stop sequences of the plurality of the power supply voltages are set down depending on characteristics of the load 7a. The term, the start and stop sequence described here defines, e.g., a rising and falling order, timings and gradients of the rising and falling, with respect to each of outputs of the POL converters 6a and 6b.

In the configuration in FIG. 3, however, there has been the problem that it was prohibitively difficult to render start and stop sequences between the POL converter 6a and 6b to desired characteristics.

FIG. 4(A) to (C) are timing charts illustrating an example of start and stop sequences of two power supply voltages, 1.8V and 3.3V input to the load 7a. In the figure, FIG. 4 (A) denotes a sequence which keeps a voltage ratio constant; FIG. 4 (B) denotes a sequence which keeps a lower voltage equal to a higher voltage until the lower voltage reaches the rated voltage; and FIG. 4 (C) denotes a sequence which allows the lower voltage to start rising after the higher voltage has started rising. Various other starting methods can be considered depending on a user's use conditions in addition to these (A) to (C) methods. Thus, since the requirements for starting and stopping more than one voltage are various, a maker cannot satisfy user requirements by defining the sequence between the POL converters 6a and 6b in advance. Even if the user defines the sequence, a major modification need to be added, such as newly providing a sequence circuit or the like to the electric power supply system.

Further, if a sequence between the POL converters 6a and 6b is defined, it has not been attained yet to monitor to control statuses of the POL converters 6a, 6b so as to make outputs of the POL converters 6a, 6b conform to the sequence without fail.

### SUMMARY OF THE INVENTION

Thus, in view of the problems described above, it is an object of the present invention to provide an electric power supply system that one electric power unit not only can deliver electric power to load or to the other power supply units but also can control and can monitor operations of the other electric power unit by the one electric power unit.

A first aspect of the present invention is an electric power supply system equipped with a master electric power unit including a controller for controlling output electric power and a slave electric power unit applying the master electric power unit as an input electric power supply. The controller is provided with a monitoring means for monitoring a status of the slave electric power unit.

Accordingly, the controller in the mater electric power unit can monitor in a lump the slave electric power unit. Hence, the master electric power unit can manage in a lump the slave electric power units installed freely according to user requirements.

A second aspect to the present invention is an electric power supply system provided with a sequence control means, in the controller, for controlling a start and stop sequence among a plurality of the slave electric power units.

Accordingly, even if not providing separately a sequence circuit in the slave electric power unit, only by setting the start and stop sequence in the master electric power unit, the start and stop sequence among a plurality of the slave electric power units can be controlled.

A third aspect of the present invention is an electric power supply system in which the controller controls output electric power of the master electric power unit based on a status of the slave electric power unit monitored by the monitoring means.

Accordingly, an output of the master electric power unit can be controlled into an optimal condition depending on, e.g., the time of failure of the slave electric power unit and conditions of a specification or the like of the slave electric power unit.

A fourth aspect of the present invention is an electric power supply system in which a controller comprises a programmable digital controller.

Accordingly, a user becomes capable of freely varying a program of the controller. Hence, desired control can be easily exercised for the master electric power unit and the slave electric power unit.

According to the present invention, the slave electric power unit freely installed by a user according to user requirements can be managed in a lump only by the master electric power unit.

According to the present invention, a sequence circuit need not be externally provided.

According to the present invention, the master electric power unit can perform optimal control in conformity with a status of the slave electric power unit.

According to the present invention, a user can easily set a start and stop sequence.

According to the present invention, the master electric power unit can be controlled optimally depending on the status of the slave electric power supply unit(s).

### BRIEF DESCRIPTION OF THE DRAWINGS

FIG. 1 is a block diagram illustrating an electric power supply system in a first embodiment of the present invention.

FIG. 2 is a block diagram illustrating an electric power supply system in a second embodiment of the present invention.

FIG. 3 is a block diagram illustrating an electric power supply system in a conventional example.

FIGS. 4(A) to 4(C) are timing charts illustrating various types of start and stop sequences of two voltages of the conventional example.

### DETAILED DESCRIPTION OF PREFERRED EMBODIMENTS

Hereunder, preferred embodiments of the electric power supply system according to the present invention are described with reference to the appended drawings. In addition, the same reference symbols are used for parts the same as in a conventional example and common descriptions are omitted for avoiding overlap.

In the electric power supply system, one electric power unit delivers electric power to a load or the other electric power unit and functions to control and monitor operations of the other electric power unit. Now, it is defined that this one electric power unit is termed a master electric power unit and the other electric power unit applying the master electric power unit as an input electric power supply is termed a slave electric power unit. The master electric power unit incorporates programmable controllers such, e.g., a micro-controller (hereunder, termed a microcomputer), DSP (Digital Signal Processor) and PLD (Programmable Logic Device) and can store programs for controlling and monitoring the other slave electric power unit. Besides, the master electric power unit has functions to control its own operation and monitor its own status. Further, the master electric power supply unit has a communications means and, e.g., is connected with a high-order device such as a computer system or like to allow statuses of the forgoing operation control and monitoring to be informed to the high-order system.

### First Embodiment

In a first embodiment, a description is given for a dispersed electric power supply system where a bus converter (an electric power source for supplying electric power to an electric power supply bus) acts as a master electric power unit and POL converters act as a slave electric power unit.

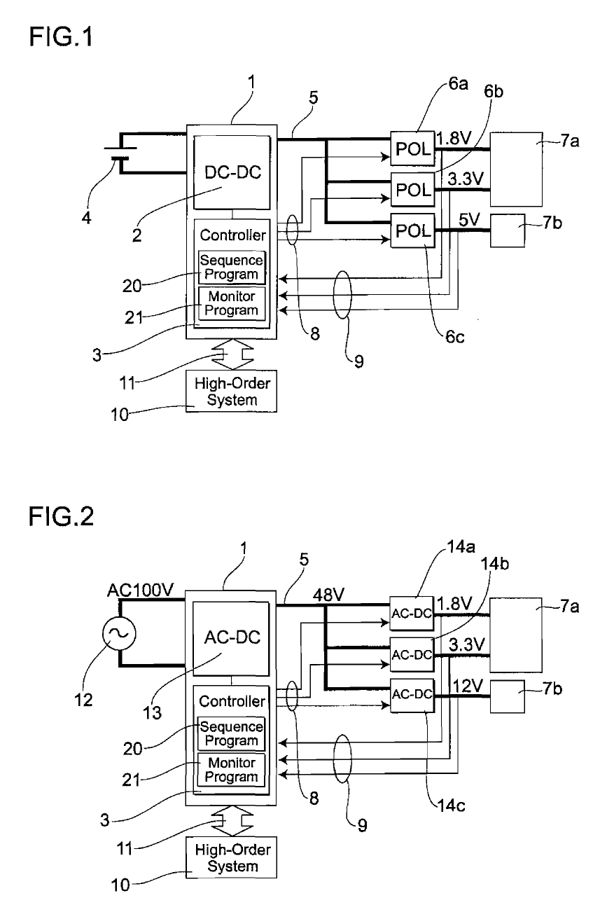

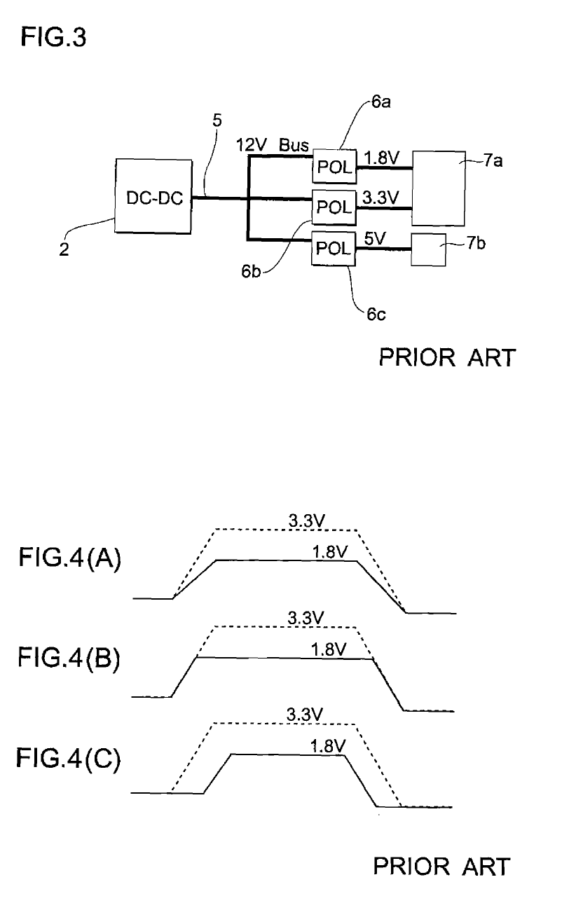

FIG. 1 is a block diagram illustrating a configuration of the electric power supply system in the first embodiment. Likewise the conventional art, in the electric power supply system, an electric power supply bus is built up by connecting an output line 5 of DC-DC converter 2 to each of the POL converters 6a, 6b, 6c. Further, each of outputs of the POL converter 6a set at 1.8V output and POL converter 6b set at 3.3V output is connected to the load 7a having double-electric-power-supply inputs, and an output of the POL converter 6c set at 5V output is connected to the load 7b which has a single-power-supply input.

The electric power unit 1 incorporates the DC-DC converter 2 and a controller 3 comprising, e.g., the microcomputer, the DSP or the like to form an integrated structure comprising these devices. The DC-DC converter 2 converts DC input electric power from an input DC power supply 4 connected to the electric power unit 1 to deliver the electric power converted to the output line 5. The controller 3 controls and monitors the DC-DC converter 2. At the same time, the controller 3 are connected to the POL converters 6a, 6b, 6c, control signal lines 8 and output monitor signal lines 9 and thereby monitors also the POL converters 6a, 6b, 6c. That is, the electric power unit 1 has functions to monitor and control statuses of the POL converters 6a, 6b, 6c as well as delivering electric power to the output line 5, e.g., to the POL converters 6a, 6b, 6c through the DC-DC converter 2.

The control signal lines 8 are transmission media of signals transmitted from the controller 3 to the POL converters 6a, 6b, 6c, e.g., a logic level signal for turning on and off the POL converters 6a, 6b, 6c (or) and a soft start signal for controlling rises of the outputs of the POL converters 6a, 6b, 6c. In addition, a control means for performing output stabilizing control of the POL converters 6a, 6b, 6c themselves is built in the POL converters 6a, 6b, 6c. On the other hand, the output monitor signal lines 9 are provided to take in, by the controller 3, each voltage output from the POL converters 6a, 6b, 6c to the loads 7a, 7b, so that the voltage information are taken in as a A-D-converted digital signal by the controller 3. Based on the voltage information, the controller 3 can control the POL converters 6a, 6b, 6c. The transmitting method of the control signal lines 8 and output monitor signal lines 9 may be, e.g., a digital serial communication or the like. In this case, the failure status generated in the POL converters 6a, 6b, 6c, a self-diagnosed result or the like can be transmitted to the controller 3 as error signals.

Further, the electric power unit 1 includes communications means to enable communication with the high-order system 10 through an interface 11. The high-order system 10 is typically a personal computer, which is operated by a user. From the high-order system 10, the monitoring and control functions can be established in the electric power unit 1 via the communications interface 11 from the high-order system 10. Specifically, a sequence program 20 acting as a sequence means inside the controller 3 which fulfils the monitoring and control functions and a monitoring program 21 acting as a monitoring means can be rewritten by the high-order system 10 to be stored in a nonvolatile memory.

The electric power unit 1 can be independently operated without being connected to the high-order system 10 in operation. Besides, the electric power unit 1 can be operated by receiving instructions from the high-order system 10 connected full-time in operation, whereas an output of the monitoring function can be also informed to the high-order system 10.

Next is a description of behavior of the electric power unit 1.

First, in consideration of characteristics of the loads 7a, 7b, the user sets down start and stop sequences of a plurality of power supply voltages and then operates the high-order system 10 to set the sequence program 20 and the monitoring program 21, which are included inside the controller 3, so as to satisfy desired conditions. Only by operating the high-order system 10, the user can set readily the start and stop sequences of the plurality of the power supply voltages, which are matched to the characteristics of the loads, and a monitoring aspect of the electric power supply system. In this manner, even if providing separately no sequence circuit in the POL 6a, 6b, only by setting the start and stop sequences of the electric power unit 1, the start and stop sequences among the plurality of the POL converters 6a, 6b can be controlled. Further, by making the sequence program 20 and the monitoring program 21 which are included inside the controller 3 rewritable by the high-order system 10, the user becomes to be able to change freely the program of the controller 3. Hence, the user can perform easily the desired control for the electric power unit 1 and the POL converters 6a, 6b, 6c.

In operation of the electric power supply system, the DC-DC converter 2 takes electric power out of the input electric power supply 4 to deliver the electric power to the POL converters 6a, 6b, 6c via the output line 5. At this time, the DC-DC converter 2 is monitored and controlled by the controller 3 to deliver stably the electric power. The POL converters 6a, 6b, 6c delivered with the electric power take the electric power out of the output line 5 to convert the electric power into the preset voltages, thus outputting the voltages to the loads 7a, 7b. As described above, the outputs of the POL converters 6a, 6b, 6c are subjected to stabilizing control by the control means built in themselves. The output voltages from the POL converters 6a, 6b, 6c are taken in the controller 3 through the output motoring signal lines 9, so that the monitoring program 21 of the controller 3 monitors the statuses of the POL converters 6a, 6b, 6c from the voltage information. Further, the monitoring program 21 informs the voltage information to the high-order system 10 via the communications interface. In this manner, by using the controller 3, the voltage monitoring of the POL converters 6a, 6b, 6c is easily possible. Then, based on the result monitored in the monitoring program 21, the sequence program 20 controls the POL converters 6a, 6b, 6c via the control signal lines 8. The statuses of the POL converters 6a, 6b, 6c can be monitored in a lump by the controller 3 and hence the POL converters 6a, 6b, 6c installed freely by user requirements can be managed in a lump.

A description is given for a specified example of control performed by the controller 3 for the POL converters 6a, 6b, 6c. The POL converters 6a, 6b, 6c are typically a non-insulating type converter and therefore short-circuiting between input and output can be presumable as a failure mode. In the failure like this, when an output voltage from any one of the POL converters 6a, 6b, 6c becomes lower than a preset value, the output voltage of the DC-DC converter 2 is lowered or blocked rapidly. As a result, the danger of excessive voltage or current application to the loads 7a, 7b can be circumvented. Besides, when the input voltage becomes higher than the output voltage, efficiencies of the POL converters 6a, 6b, 6c tends to be lowered. In accordance with a maximum output voltage among the output voltages from the plurality of the POL converters 6a, 6b, 6c, the controller 3 regulates automatically the output voltage of the DC-DC converter 2 in conformity to a maximum voltage among the output voltages from a plurality of the POL converters 6a, 6b, 6c. For example, when the output voltages of the POL converters 6a, 6b are assumed to be 5V and 2.5 V, respectively, the input voltage Vin is made equal to the larger voltage to thus be made 5V. As a result, the efficiencies of the POL converters 6a, 6b, 6c can be optimized.

As a modified example of the electric power supply system, the output of the DC-DC converter 2 can be also monitored with respect to its current by means of a CT (a current transformer). In this case, as is the case with the voltage monitoring, the current information is informed to the high-order system 10 and at the same time a change in setting can be performed to the sequence program 20 and the monitoring program 21 of the controller 3 from the high-order system 10. In this case, a specified example of control performed by the controller 3 for the POL converters 6a, 6b, 6c is as follows: a maximum output rating of the DC-DC converter 2 is assumed to be, e.g., 12V and 20A, and when an input current Iin flowing into the POL converters 6a, 6b, 6c trough the output line 5 is in the order of 5A when having first connected the POL converters 6a, 6b, 6c to the DC-DC converter 2, an operating point of OCP (Over Current Protection) of the DC-DC converter 2 is allowed to be changed into about 10A in response to this input current in.

As stated above, the electric power supply system in the present embodiment is provided with the electric power unit 1 (a DC-DC converter 2), acting as a master electric power unit including the controller 3 for controlling the output electric power and the POL converters 6a, 6b, 6c, acting as the slave electric power unit, which applies this electric power unit 1 as its input electric power supply. Besides, in the controller 3, there is provided the monitoring program 21 acting as a monitoring means for monitoring the statuses of the POL converters 6a, 6b, 6c.

Accordingly, the statuses of the POL converters 6a, 6b, 6c can be monitored in a lump by the controller 3 of the electric power unit 1 and hence the POL converters 6a, 6b, 6c installed depending on user requirements can be managed in a lump by the electric power unit 1.

Further, in the present embodiment, in the controller 3, there is provided the sequence program 20 acting as a sequence control means for controlling the start and stop sequence among the plurality of the POL converters 6a, 6b, 6c.

Accordingly, even if there is provided separately no sequence circuit in the POL converters 6a, 6b, only by installing the start and stop sequence in the electric power unit 1, the start and stop sequence between the plurality of the POL converters 6a, 6b can be controlled.

Furthermore, in the present embodiment, based on the statuses of the POL converters 6a, 6b, 6c which have been monitored by the monitoring program 21, the controller 3 controls the output electric power of the electric power unit 1.

Accordingly, for example, at the time of failure of the POL converters 6a, 6b, 6c and depending on the statuses of the POL converters 6a, 6b, 6c, an output of the electric power unit 1 can be optimally controlled.

Moreover, in the present embodiment, the controller 3 comprises a programmable digital controller.

Accordingly, the user becomes to be capable of changing freely the program of the controller 3 and hence a desired control can be easily performed for the electric power unit 1 and the POL converters 6a, 6b, 6c.

### Second Embodiment

In a second embodiment, a description is given for a dispersed electric power supply system where a front end electric source (outputs DC 48V and so on by an AC input) acts as a master electric power unit and the DC-DC converter having the front end electric source as an input acts as a slave electric power unit.

FIG. 2 is a block diagram illustrating a configuration of an electric power supply system in the second embodiment. In the electric power supply system, a basic configuration is approximately the same as that in the first embodiment except for the master electric power unit and the slave electric power unit.

The electric power unit 1 in the figure incorporates an AC-DC converter 13 and a controller 3 therein. The AC-DC converter 13 converts an AC input electric power from an AC input power source 12 such as, e.g., a commercial power source connected to the electric power unit 1 and then delivers the electric power converted to an output line 5. DC 48V is delivered to the output line 5 and is connected to each of the AC-DC converters 14a, 14b, 14c. Output voltages of the AC-DC converters 14a, 14b, 14c are set as 1.8V, 3.3V, 12V, respectively. A two-electric-source-input type load 7a is connected to each of outputs of the AC-DC converters 14a, 14b, while one-electric-source-input type load 7b is connected to an output of the AC-DC converters 14c. The rests of the configuration and the behavior are the same as those in the first embodiment.

In addition, the present invention is not limited to the embodiment described above and modifications are possible within the scope not departing from the gist of the present invention. All kinds of electric power units can be applied to the master and slave electric power units of the present invention and therefore the number of configurations of the electric power units and connection forms are not particularly limited.

What is claimed:

1. An electric power supply system comprising:
a master electric power unit including a controller for controlling output electric power, and
a slave electric power unit which applies said master electric power unit as an input electric source,
wherein said controller is provided with a monitoring means which monitors a status of said slave electric power unit.

2. The electric power supply system according to claim 1, wherein said controller is provided with a sequence control means which controls a start and stop sequence among a plurality of said slave electric power units.

3. The electric power supply system according to claim 1, wherein said controller controls output electric power of said master electric power unit based on a status of said slave electric power unit that is monitored by said monitoring means.

4. The electric power supply system according to claim 3, wherein said monitoring means takes in output voltages from a plurality of said slave electric power units to monitor statuses of said slave electric power units, and wherein when an output voltage from at least one of said slave electric power units gets lower than a preset value, said controller decreases or blocks output voltages supplied from said master electric power unit to said plurality of said slave electric power units.

5. The electric power supply system according to claim 3, wherein said monitoring means takes in output voltages from a plurality of said slave electric power units to monitor statuses of said slave electric power units, and wherein said controller automatically regulates output voltages supplied from said master electric power unit to said plurality of said slave electric power units in conformity to a maximum output voltage of output voltages from said plurality of said slave electric power units.

6. The electric power supply system according to claim 3, wherein said monitoring means takes in an input current flowing into said slave electric power unit to monitor a status of said slave electric power unit and besides said controller performs a change in setting of an operating point of OCP of said master electric power unit depending on said current flowing into said slave electric power unit when having first connected said slave electric power unit to said master electric power unit.

7. The electric power supply system according to claim 1, wherein said controller comprises a programmable digital controller.

8. The electric power supply system according to claim 1, wherein said controller is provided with a sequence control means which controls a start and stop sequence among a plurality of said slave electric power units, and wherein said controller controls output electric power of said master electric power unit based on statuses of said slave electric power units that have been monitored by said monitoring means.

9. The electric power supply system according to claim 8, wherein said controller comprises a programmable digital controller.
